(19) United States
(12) Patent Application Publication
(10) Pub. No.: US 2005/0092285 A1
(43) Pub. Date: May 5, 2005

(54) System and method for improving ignitability of dilute combustion mixtures

(76) Inventors: George P. Klonis, New Berlin, WI (US); Michael Paul Thompson, Mukwonago, WI (US); William A. Draeger, Waukesha, WI (US)

Correspondence Address: FISH & RICHARDSON P.C., 5000 BANK ONE CENTER, 1717 MAIN STREET, DALLAS, TX, 75201, US

(21) Appl. No.: 10/700,039

(22) Filed: Nov. 3, 2003

(51) Int. Cl. F02B 19/18

(52) U.S. Cl. 123/266; 123/293

(57) ABSTRACT

An internal combustion engine includes a body defining at least a portion of a combustion chamber. The combustion chamber is adapted to receive a combustion mixture. A cavity in the body has an open end in fluid communication with the combustion chamber. The cavity is adapted to receive a portion of the combustion mixture in the combustion chamber through the open end such that substantially all of the combustion mixture received in the cavity is the combustion mixture received from the combustion chamber. An ignition source resides in the cavity at an end opposite the open end. An apertured member is adjacent to the ignition source and has one or more apertures therein. The apertures are operable to allow passage of the combustion mixture to the ignition source and, upon ignition of the combustion mixture in the cavity, jet a portion of the ignited combustion mixture into the combustion chamber.

The U.S. Government has a paid-up license in this invention and the right in limited circumstances to require the patent owner to license other on reasonable terms as provided for by the terms of DE-FC02-01CH11080; W(A)-027; CH-1073 awarded by the Department of Energy.

### TECHNICAL FIELD

This invention relates to internal combustion engines, and more particularly to igniting a fuel and air mixture within an internal combustion engine.

### BACKGROUND

In an effort to reduce fuel consumption and emissions, engine designers have begun producing engines that, at times, run with a dilute combustion mixture or charge. For example, the charge may have more oxygen, and correspondingly less fuel, than is necessary to achieve stoichiometric combustion. The diluents may also be inert, for example, exhaust gas in a system with exhaust gas recirculation (EGR) or other diluents. There are difficulties, however, to running an engine on a dilute charge. For example, a dilute charge is subject to misfire, because it is difficult to ignite and once ignited the dilute charge does not burn stably within the cylinder. Such misfire manifests as reduced power output, increased fuel consumption, and higher than desired emissions. Accordingly, engine designers have taken various measures to address the difficulties to running an engine with a dilute charge.

Some engine designs have included a pre-chamber outside of the primary combustion chamber that receives additional fuel over that supplied to the primary combustion chamber. The additional fuel creates a richer combustion mixture in the pre-chamber that is easier to ignite and produces a more stable flame than the dilute combustion mixture in the primary combustion chamber. The richer mixture in the pre-chamber is thus ignited and released into primary combustion chamber to ignite the dilute combustion mixture in the primary combustion chamber. However, by providing additional fuel to the pre-chamber the overall amount of fuel introduced into the combustion chamber is greater, and this, to some degree, increases fuel consumption and emissions.

In other engine designs, the combustion chamber is configured to produce a stratified combustion mixture having a richer mixture near the ignition source. The stratified mixture is achieved, for example, by introducing fuel into the combustion chamber near the ignition source or by injecting fuel or the combustion mixture in a manner that induces a non-homogeneous distribution of the combustion mixture that is richer about the ignition source. The richer combustion mixture near the ignition source is ignited, and the resulting flame is stronger and propagates more stably into the more dilute areas of the combustion mixture than would a flame originated in the dilute portion of the combustion mixture. Unfortunately, it is difficult to consistently achieve a stratified combustion mixture without forming pockets of combustion mixture that are too dilute to readily combust. The areas of combustion mixture that are too dilute to readily combust may not combust completely thereby resulting in reduced efficiency of the engine because of the unburned fuel, as well as increased emissions.

Therefore, there is a need for a system and method of combusting dilute combustion mixtures that do not require additional fuel be introduced to the combustion chamber and that is easily implemented.

### SUMMARY

The invention generally encompasses a system and method of combusting a dilute combustion mixture by creating an area of the mixture that is easier to ignite and more stably combusts.

An illustrative embodiment in accordance with the invention includes an internal combustion engine. The internal combustion engine includes a body defining at least a portion of a combustion chamber. The combustion chamber is adapted to receive a combustion mixture. A compression member in the combustion chamber is adapted to substantially seal with the body and is movable to compress the combustion mixture. A cavity in the body has an open end in fluid communication with the combustion chamber. The cavity is adapted to receive a portion of the combustion mixture in the combustion chamber through the open end such that substantially all of the combustion mixture received in the cavity is the combustion mixture received from the combustion chamber. The cavity is further adapted to create a substantially quiescent area therein. An ignition source resides in the cavity at an end opposite the open end. An apertured member is adjacent to the ignition source and has one or more apertures therein. The apertures are operable to allow passage of the combustion mixture to the ignition source and, upon ignition of the combustion mixture in the cavity, jet a portion of the ignited combustion mixture into the combustion chamber.

Another illustrative embodiment in accordance with the invention includes a carrier for receiving an ignition source and mounting in an internal combustion engine. The carrier includes a carrier housing adapted to receive the ignition source. An exterior shoulder on the carrier housing is adapted to abut the internal combustion engine and position the carrier in relation to the internal combustion engine with the ignition source outside of the combustion chamber. The carrier housing is further adapted to cooperate with the internal combustion engine to form a substantially quiescent area about the ignition source. The carrier may include an apertured housing at one end of the carrier housing having one or more apertures adapted to allow passage of fluids into an interior of the carrier housing and to jet at least a portion of the fluids out of the carrier housing when at least a portion of the fluids is ignited. Here, the carrier housing is adapted to cooperate with at least the apertured housing to form a substantially quiescent area about the ignition source.

Another illustrative embodiment in accordance with the invention includes a method of igniting a dilute combustion mixture in a combustion chamber of an internal combustion engine. According to the method a dilute combustion mixture is received in the combustion chamber. At least a portion of the dilute combustion mixture from the combustion chamber is received through an open end of a cavity such that substantially all of the combustion mixture in the cavity is the dilute combustion mixture received from the combustion chamber. The cavity is outside of the combustion chamber and substantially protects the dilute combustion mixture therein from fluid flows in the combustion chamber without inducing substantial additional flows therein. The dilute combustion mixture in the cavity is ignited with an ignition source in the cavity opposite the open end. The dilute combustion mixture in the combustion chamber is ignited with the ignited dilute combustion mixture from the cavity.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a cross sectional view of an engine constructed in accordance with the invention incorporating a non-shielded spark plug;

FIG. 2 is a cross sectional view of a cylinder head constructed in accordance with the invention incorporating a shielded spark plug; and

FIG. 3 is a cross section view of an engine constructed in accordance with the invention incorporating a spark plug carrier having a shield housing.

Like reference symbols in the various drawings indicate like elements.

### DETAILED DESCRIPTION

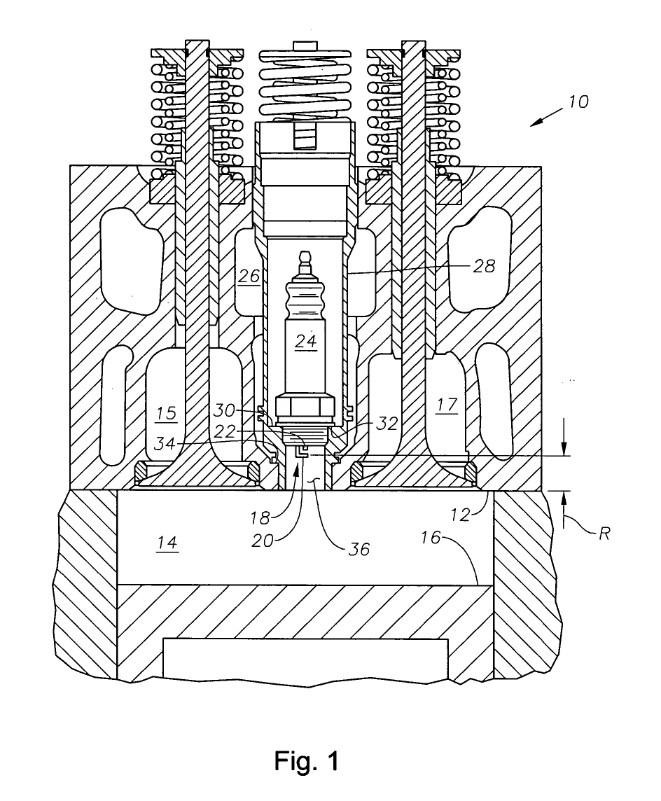

Referring first to FIG. 1, a cross section of an internal combustion engine constructed in accordance with the invention is depicted. The engine includes a head 10 that forms at least a portion of a wall surface 12 of a combustion chamber 14. In the illustrative embodiment of FIG. 1, the combustion chamber 14 is of a cylindrical configuration and receives a cylindrical piston 16 to linearly reciprocate therein. Although discussed herein in reference to the cylindrical combustion chamber 14 and linearly reciprocating piston 16 of FIG. 1, the invention is equally applicable to other types of internal combustion engines, for example, a Wankel type rotary engine. Therefore, it is to be understood that the inventive concepts described herein are not limited to the illustrative linearly reciprocating engine of FIG. 1.

The engine further includes an intake passage 15 operable to enable flow of air, such as in a direct injection engine configuration, or an air and fuel mixture, such as in a carbureted or non-direct injection engine configuration, into the combustion chamber 14. An exhaust passage 17 is also provided and operable to enable flow of exhaust out of the combustion chamber 14.

The head 10 incorporates an ignition source 18, depicted in the illustrative embodiment of FIG. 1 as the ground electrode 20 and center electrode 22 of a J-type spark plug 24. Although described herein as components of a spark plug 24, the ignition source 18 may be any other type of ignition source suitable for application to an internal combustion engine. The spark plug 24 is received in an open space 26 in the head 10. The head 10 can be configured to receive and engage the spark plug 24 directly or the head 10 can be configured to receive and engage a spark plug carrier 28 that receives and engages a spark plug 24 or other type of ignition source 18. In one illustrative embodiment, the spark plug carrier 28 can be threadingly engaged by the head 10, and can, in turn, threadingly engage the spark plug 24. It is also within the scope of the invention that the spark plug carrier 28 be clamped into the head 10, frictionally retained in the head 10, welded or adhered in the head 10, or otherwise.

The spark plug carrier 28 is of a tubular configuration and open to the combustion chamber 14 at one end to communicate fluids into the interior of the spark plug carrier 28. The spark plug 24 has a seat 32 that abuts and substantially seals against a shoulder 30 in the interior of the spark plug carrier 28. The shoulder 30 serves to position the spark plug 24 in relation to the carrier 28. The spark plug carrier 28 has a shoulder 34 that abuts an interior of the open space 26 to position the carrier 28 in relation to the head 10, and thus the wall surface 12 of the combustion chamber 14. The position of the shoulder 30 of the spark plug carrier 28 and the shoulder 34 of the head 10 are chosen to position the ignition source 18 a predetermined distance from the interior of the combustion chamber 14 and create a protected area 36. Within the protected area 36, at least the area about the ignition source 18 is substantially quiescent.

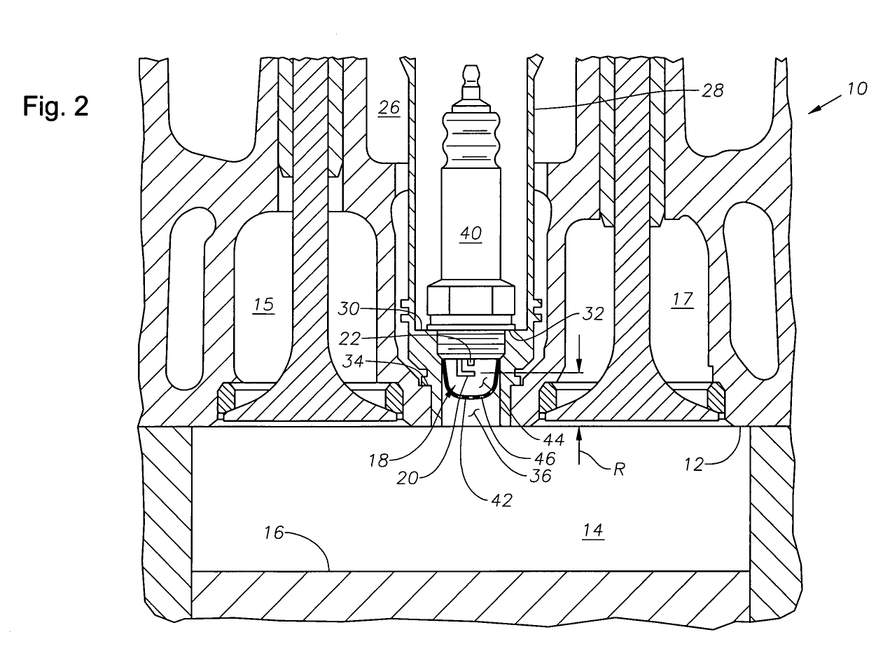

FIG. 2 depicts an alternate illustrative embodiment incorporating a shielded type spark plug 40 in the spark plug carrier 28 and head 10 arrangement discussed above. The shielded type spark plug 40 includes a shield housing 42 surrounding the ignition source 18. The shield housing 42 defines a shielded area 44 coinciding with at least a portion of the protected area 36. The shield housing 42 may reside within the protected area 36 as depicted in FIG. 2 or may protrude at least partially into the combustion chamber 14. One or more apertures 46 are provided in the shield housing 42 to allow passage of fluids through the housing 42. The number, shape, size and orientation of the apertures 46 are configured to allow passage of the charge from the combustion chamber 14 into the shielded area 44, and further to operate as nozzles to inject combusting and uncombusted charge from the shielded area 44 into the combustion chamber 14 after the charge in the shielded area 44 is ignited. In other words, a portion of the charge from the combustion chamber 14 enters the shielded area 44 and is ignited by the ignition source 18. As the charge in the shielded area 44 combusts, the pressure in the shielded area 44 rises abruptly and forcefully ejects combusting and uncombusted charge through the apertures 46. The apertures 46 concentrate the ejected charge from the shielded area 44 into one or more streams (typically one stream per aperture 46) that travel quickly and deeply into the combustion chamber 14. The injected combusting charge thus ignites the charge in the combustion chamber 14 in a manner improved over a conventional engine igniting from a spark plug at the periphery of the combustion chamber, because the charge is ignited at multiple points in the combustion chamber 14, i.e. the streams, and from deeper within the combustion chamber 14.

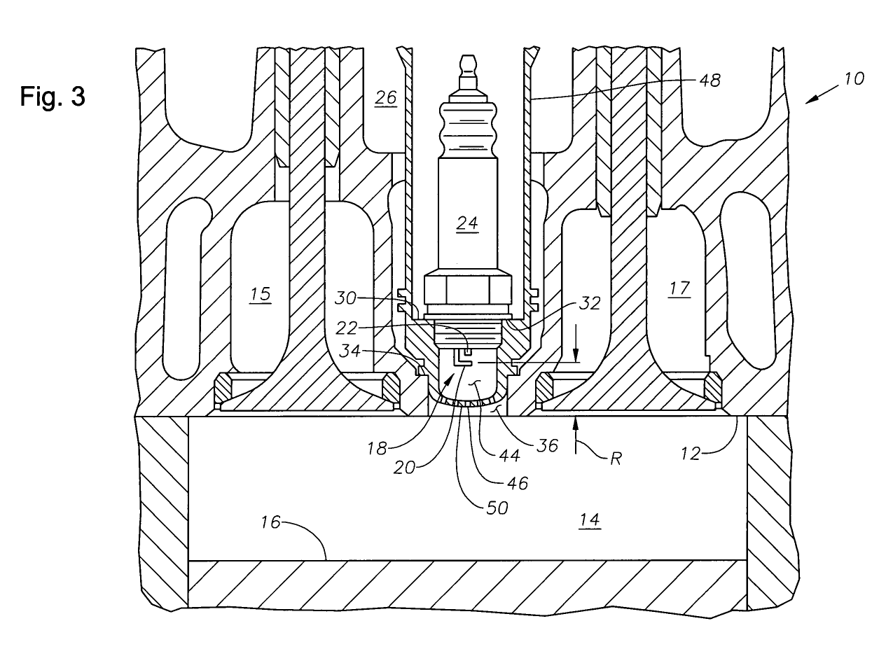

FIG. 3 depicts an alternate illustrative embodiment incorporating a spark plug carrier 48 with an integral shield housing 50 substantially surrounding the ignition source 18. The integral shield housing 50 includes one or more apertures 46 configured, as above, to operate as nozzles to inject combusting and uncombusted charge into the combustion chamber 14 after the charge in the shielded area 44 is ignited. The integral shield housing 50 can reside in the protected area 36 as depicted in the figures or at least partially protruding into the combustion chamber 14.

Use of a spark plug carrier 28 or 48 enables the spark plug position and provision of a shield housing 42 and 50 to be modular for a particular head 10 configuration. Multiple spark plug carriers 28 or 48 can be provided that fit a particular head 10 configuration and that each provide for a different positioning of the spark plug 24 or 40. Depending on the desired position of the spark plug 24 or 40 in relation to the combustion chamber 14 and whether a shield housing 50 is desired, the appropriate spark plug carrier 28 or 48 is selected. The spark plug carriers 28 and 48 thus eliminate the need for multiple head 10 configurations to provide for differing desired spark plug position and inclusion of the shield housing.

With reference to FIGS. 1-3 collectively, the ignition source 18 is positioned in relation to the combustion chamber 14 in a manner that promotes more complete and consistent ignition of the charge, even if the charge is dilute. For convenience of reference herein, the distance from the ignition source 18 to the wall surface 12 of the combustion chamber 14 is referred to as recess distance R. The recess distance R is chosen such that the ignition source 18 resides substantially outside of the combustion chamber 14 and to define a protected area 36 between the ignition source 18 and the combustion chamber 14 that is conducive to igniting the charge. The protected area 36 is configured such that at least the charge adjacent the ignition source 18 is substantially protected from turbulence and other fluid movement within the combustion chamber 14, i.e. quiescent. Further, the protected area 36 can be adapted to maintain the charge adjacent the ignition source 18 without additional induced turbulence or swirl, i.e. maintain the charge substantially quiescent. In some instances, it may be desirable to induce flow about the opening of the protected area 36 to more quickly fill the protected area 36 with charge.

In the illustrative embodiments of the figures, ignition source 18 is recessed so that at least the center electrode 22 is outside of the combustion chamber 14. The protected area 36 is bounded by the spark plug 24 or 40, the wall surface 12 of the combustion chamber 14, and the carrier 28 or 48. The ignition source 18 may be positioned at an end opposite the open end of the protected area 36 as depicted in FIG. 1, or may be positioned at another position in the protected area 36. In embodiments including a shield housing 42 or 50, the shield housing 42 or 50 operates to assist in making at least a portion of the shielded area 44 quiescent. In each of the various illustrative embodiments, the protected area 36 is substantially cylindrical, communicating with the combustion chamber 14 at one end and having the spark plug 24 or 40 at the other opposing end. Configuring the longitudinal central axis of the protected area 36 to substantially coincide with a longitudinal central axis of the spark plug 24 or 40, as in the illustrative embodiments, provides a space efficient configuration that does not intrude into other areas of the head 10. However, although depicted herein as being substantially cylindrical, the protected area 36 need not be cylindrical and can embody other non-cylindrical configurations, such as spherical, cubic, pyramidal, or irregular. Furthermore, the longitudinal central axis of the protected area 36 may be provided offset from and angled to the longitudinal axis of the spark plug 24 or 40 if so desired.

As the charge is introduced into the combustion chamber 14, a portion migrates into the protected area 36. This portion of the charge in the protected area 36 has substantially the same make-up as the charge in the combustion chamber 14. Therefore, if a dilute charge, such as a charge that has been diluted with excess oxygen (i.e. a lean charge) and/or that has been diluted with inert diluents, is introduced into the combustion chamber 14, the portion of the charge in the protected area 36 will have substantially the same ratio of diluents as the charge in the combustion chamber.

Ignition source 18 ignites the portion of the charge in the protected area 36, and the ignited charge in the protected area 36, in turn, ignites the remainder of the charge in the combustion chamber 14. Because the area about the ignition source 18 is sheltered and relatively undisturbed by turbulence and other fluid flows in the combustion chamber 14, the portion of the charge about the ignition source 18 in the protected area 36 is more readily ignited than if it were in the combustion chamber 14. Furthermore, the flame kernel resulting is able to grow at a controlled rate and become established before entering the combustion chamber 14. The flame thus has substantial energy and size to stably propagate through and ignite the charge in the combustion chamber 14. The result is a more complete and more consistent ignition of the mixture in the combustion chamber 14. The more complete and more consistent ignition is manifest in a lower coefficient of variance in indicated man effective pressure (IMEP) between firing cycles, and a lower standard deviation of 0-10% mass fraction burn (MFB).

Recessing the ignition source 18 from the combustion chamber 14 creates a delay between firing the ignition source 18 and ignition of the charge in the combustion chamber 14, because the flame must travel from the protected area 36 into the combustion chamber 14. The amount of delay is a function of the recess distance R, i.e. the greater the recess distance R the more ignition delay, and can be tuned as is desired for the specific combustion system (compression ratio, piston-bowl shape, etc.). To compensate for the delay, the engine's ignition timing is advanced so that the charge in the combustion chamber 14 is ignited at approximately the same crank angle as it would have been ignited in an engine without a recessed ignition source 18. Because of the timing advance, the ignition source 18 is fired earlier in the compression stroke when the pressure in the combustion chamber 14 and protected area 36 is lower. At such lower pressure, the energy required to ignite the charge in the protected area 36 is lower than at higher pressures. Thus, in the case of a spark plug 24 or 40, the spark plug voltage demand is lower and spark plug life increased. By contrast, reducing the spark plug demand voltage in conventional systems is difficult without negatively impacting fuel consumption, emissions or knock margin. An additional advantage of recessing the ignition source 18 is greater heat transfer between the spark plug 24 or 40 and the head 10 resulting in lower spark plug tip and seat temperatures.

A number of embodiments of the invention have been described. Nevertheless, it will be understood that various modifications may be made without departing from the spirit and scope of the invention. Accordingly, other embodiments are within the scope of the following claims.

1. An internal combustion engine, comprising:
a head defining at least a portion of a main combustion chamber, the main combustion chamber adapted to receive a dilute combustion mixture;
a compression member in the main combustion chamber movable to compress the dilute combustion mixture;
an auxiliary combustion cavity in the cylinder head disposed adjacent to and having an open end in fluid communication with the main combustion chamber, the auxiliary combustion cavity being adapted to receive a portion of the dilute combustion mixture through the open end such that substantially all of the dilute combustion mixture received in the auxiliary combustion cavity is provided from a portion of the combustion mixture received in the main combustion chamber;
an ignition source residing in the auxiliary combustion cavity substantially at an end of the cavity opposing the open end; and
an apertured member adjacent to the ignition source and having one or more apertures therein, the apertures operable to allow passage of the combustion mixture from the combustion mixture supplied to the main combustion chamber to the ignition source and, upon ignition of the combustion mixture in the auxiliary combustion cavity, jet a portion of the ignited combustion mixture from the auxiliary combustion cavity into the main combustion chamber.

2. (canceled)

3. The internal combustion engine of claim 1 wherein the compression member is a piston reciprocating in the main combustion chamber.

4. The internal combustion engine of claim 1 wherein the head is a cylinder head.

5. The internal combustion engine of claim 1 further comprising a carrier housing removably received in the head; and
wherein the ignition source is carried by the carrier housing.

6. The internal combustion engine of claim 5 wherein the apertured member resides on the carrier housing.

7. The internal combustion engine of claim 6 wherein the apertured member is a shield housing encasing the electrode of the ignition source.

8. The internal combustion engine of claim 1 wherein the apertured member is a housing encasing at least a portion of the ignition source.

9. The internal combustion engine of claim 1 wherein the apertured member is between the open end and the ignition source.

10. The internal combustion engine of claim 1 wherein the ignition source is at the end of the cavity opposing the open end.

11. The internal combustion engine of claim 1 wherein the ignition source is a center and ground electrodes of a spark plug.

12. The internal combustion engine of claim 11 wherein the apertured member resides on the spark plug.

13. The internal combustion engine of claim 1 wherein the head is adapted to receive in at least one auxiliary combustion cavity either a first carrier housing adapted to position the ignition source at a first position in relation to the main combustion chamber, or a second carrier housing adapted to position the ignition source at a second position in relation to the main combustion chamber, but not both carriers being received at the same time in the same auxiliary combustion cavity.

14. The internal combustion engine of claim 13 wherein the head is adapted to receive at least a first carrier housing and a second carrier housing, the first carrier housing adapted to carry the ignition source and having the apertured member thereon and the second carrier housing adapted to carry the ignition source and that omits the apertured member.

15. The internal combustion engine of claim 1 wherein the ignition source is a center and ground electrodes of a spark plug; and
wherein cavity is substantially cylindrical and a longitudinal central axis of the cavity substantially coincides with a longitudinal central axis of the spark plug.

16. A carrier for receiving an ignition source and mounting in an internal combustion engine, the internal combustion engine having at least one combustion chamber, the carrier comprising:
a carrier housing adapted to receive the ignition source; and
an exterior shoulder on the housing adapted to abut the internal combustion engine and position the carrier in relation to the internal combustion engine with the ignition source outside of the combustion chamber, the carrier housing further adapted to cooperate with the internal combustion engine to form a substantially quiescent area about the ignition source.

17. The carrier of claim 16 wherein the ignition source is a center and at least one ground electrode of a spark plug.

18. The carrier of claim 17 further comprising an internal shoulder in the housing adapted to abut the spark plug and position the spark plug axially in relation to the carrier housing; and
wherein the internal shoulder and the external shoulder cooperate to position at least the center electrode outside of the combustion chamber.

19. The carrier of claim 16 wherein the carrier housing is substantially tubular; and
wherein the carrier further comprises an apertured shield at one end of the carrier housing adapted to jet fluids within the carrier into the internal combustion engine.

20. The carrier of claim 16 wherein the carrier is adapted to threadingly engage the internal combustion engine.

21. The carrier of claim 16 wherein the carrier is adapted to be clamped to the internal combustion engine.

22. The carrier of claim 16 wherein the carrier housing is adapted to receive a spark plug having a shield housing substantially encasing at least a portion of the spark plug.

23. A carrier for receiving a spark plug and mounting in an internal combustion engine, comprising:
a substantially tubular carrier housing adapted to receive a spark plug therein; and
an apertured housing at one end of the carrier housing having one or more apertures adapted to allow passage of fluids into an interior of the carrier housing and to jet at least a portion of the fluids out of the carrier housing when at least a portion of the fluids is ignited, the carrier housing adapted to cooperate with at least the apertured housing to form a substantially quiescent area about the ignition source.

24. The carrier of claim 23 further comprising an external shoulder on the carrier housing adapted to abut the internal combustion engine and position the carrier in relation to the internal combustion engine with the spark plug outside of a combustion chamber of the engine.

25. The carrier of claim 24 further comprising an internal shoulder in the carrier housing adapted to abut the spark plug and axially position the spark plug relative to the carrier housing.

26. The carrier of claim 23 wherein the internal combustion engine has a combustion chamber and a cavity in communication with the combustion chamber; and
wherein the carrier housing is adapted to be received in the cavity.

27. The carrier of claim 23 wherein the carrier housing is adapted to threadingly engage the internal combustion engine.

28. The carrier of claim 23 wherein the carrier is adapted to be clamped to the internal combustion engine.

29. A method of combusting a dilute combustion mixture in a main combustion chamber of an internal combustion engine, comprising:
providing a dilute combustion mixture to a main combustion chamber;
receiving in an auxiliary combustion cavity at least a portion of the dilute combustion mixture from the main combustion chamber through an open end of the auxiliary combustion cavity such that substantially all of the dilute combustion mixture in the auxiliary combustion cavity is the dilute combustion mixture received from the main combustion chamber, the auxiliary combustion cavity being disposed adjacent to and outside of the main combustion chamber;
positioning an ignition source in the auxiliary combustion cavity opposite the open end at sufficient distance from the main combustion cavity to protect at least a portion of the dilute combustion mixture adjacent the ignition from fluid flows in the main combustion chamber;
igniting with the ignition source the dilute combustion mixture in the auxiliary combustion cavity; and
igniting at least a portion of the dilute combustion mixture in the main combustion chamber with the ignited dilute combustion mixture from the auxiliary combustion cavity.

30. The method of claim 29 further comprising jetting combusting dilute combustion mixture from the cavity into the combustion chamber through at least one aperture.

31. The method of claim 29 wherein the ignition source is a spark plug.

32. The method of claim 29 wherein the internal combustion engine is a reciprocating internal combustion engine.

33. The method of claim 29 wherein igniting the dilute combustion mixture in the cavity comprises supplying a voltage to the ignition source that is less than a voltage that would be required by the ignition source were it positioned outside of the cavity and in the combustion chamber.

34. The method of claim 29 wherein a temperature of the ignition source is less than a temperature of the ignition source were it positioned outside of the cavity and in the combustion chamber.

35. A component of an internal combustion engine system comprising:
a head defining at least a portion of a main combustion chamber, the main combustion chamber adapted to receive a dilute combustion mixture charge;
a compression member in the main combustion chamber movable to compress the dilute combustion mixture charge;
an auxiliary combustion cavity in the head disposed adjacent to and having an open end in fluid communication with the main combustion chamber, the auxiliary combustion cavity being adapted to receive a dilute portion of the combustion mixture through the open end such that substantially all of the dilute combustion mixture received in the auxiliary combustion cavity is provided from a portion of the combustion mixture received from the main combustion chamber; and
an ignition source residing in the auxiliary combustion cavity, the cavity adapted to create a substantially quiescent area about the ignition source.

36. (canceled)

37. The component of an internal combustion engine system of claim 35 wherein the head is a cylinder head.

38. The component of an internal combustion engine system of claim 35 further comprising a carrier housing removably received in the head; and
wherein at least a portion of the ignition source is disposed in the carrier housing.

39. The component of an internal combustion engine system of claim 38 further comprising an apertured member residing on the carrier housing.

40. The component of an internal combustion engine system of claim 39 wherein the apertured member is a shield housing encasing the electrode of the ignition source.

41. The component of an internal combustion engine system of claim 35 further comprising an apertured member encasing at least a portion of the ignition source.

42. The component of an internal combustion engine system of claim 41 wherein the apertured member is between the open end and the ignition source.

43. The component of an internal combustion engine system of claim 35 wherein the ignition source is at the end of the cavity opposing the open end.

44. The component of an internal combustion engine system of claim 35 wherein the ignition source is a center and ground electrodes of a spark plug.

45. The component of an internal combustion engine system of claim 35 wherein the head is adapted to receive in at least one auxiliary combustion cavity either a first carrier housing adapted to position the ignition source at a first position in relation to the main combustion chamber, or a second carrier housing adapted to position the ignition source at a second position in relation to the main combustion chamber, but not both carriers being received at the same time in the same auxiliary combustion cavity.

46. The component of an internal combustion engine system of claim 45 wherein the head is adapted to receive at least a first carrier housing and a second carrier housing, the first carrier housing adapted to carry the ignition source and having the apertured member thereon and the second carrier housing adapted to carry the ignition source and that omits the apertured member.

47. The internal combustion engine system of claim 43 wherein the longitudinal central axis of the auxiliary combustion cavity substantially coincides with the longitudinal axis of the ignition source.

48. The internal combustion component of claim 35 wherein the ignition source is disposed in the auxiliary combustion cavity a sufficient distance from the main combustion chamber to protect at least a portion of the dilute combustion mixture adjacent the ignition from fluid flows in the main combustion chamber.
